(19) United States
(12) Patent Application Publication
(10) Pub. No.: US 2025/0300796 A1
(43) Pub. Date: Sep. 25, 2025

(54) HYBRID AUTOMATIC REPEAT REQUEST FEEDBACK DURING AND OUTSIDE CHANNEL OCCUPANCY TIME

(71) Applicant: QUALCOMM Incorporated, San Diego, CA (US)

(72) Inventors: Shaozhen GUO, Beijing (CN); Chih-Hao LIU, San Diego, CA (US); Changlong XU, Beijing (CN); Jing SUN, San Diego, CA (US); Xiaoxia ZHANG, San Diego, CA (US); Luanxia YANG, Beijing (CN); Siyi CHEN, Beijing (CN); Hao XU, Beijing (CN)

(21) Appl. No.: 18/869,683

(22) PCT Filed: Jul. 13, 2022
(86) PCT No.: PCT/CN2022/105368

§ 371 Date: Nov. 26, 2024

(51) Int. Cl. H04L 5/14; H04L 1/1829; H04W 92/18

(52) U.S. Cl. CPC H04L 5/14; H04L 1/1854; H04W 92/18

(57) ABSTRACT

Various aspects of the present disclosure generally relate to wireless communication. In some aspects, a user equipment (UE) may determine whether a physical sidelink feedback channel (PSFCH) transmission is scheduled during a channel occupancy time (COT). Accordingly, the UE may transmit the PSFCH transmission using a first set of resources based at least in part on determining that the PSFCH transmission is scheduled outside the COT. Alternatively, the UE may transmit the PSFCH transmission using a second set of resources based at least in part on determining that the PSFCH transmission is scheduled in the COT. Numerous other aspects are described.

### FIELD OF THE DISCLOSURE

Aspects of the present disclosure generally relate to wireless communication and to techniques and apparatuses for transmitting and receiving hybrid automatic repeat request feedback during and outside channel occupancy time.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include determining whether a physical sidelink feedback channel (PSFCH) transmission is scheduled during a channel occupancy time (COT). The method may include transmitting the PSFCH transmission using a first set of resources based at least in part on determining that the PSFCH transmission is scheduled outside the COT, or transmitting the PSFCH transmission using a second set of resources based at least in part on determining that the PSFCH transmission is scheduled in the COT.

Some aspects described herein relate to a method of wireless communication performed by a UE. The method may include monitoring a PSFCH using a first set of resources that is associated with feedback received during a COT. Additionally, or alternatively, the method may include monitoring the PSFCH using a second set of resources that is associated with feedback received outside the COT.

Some aspects described herein relate to a method of wireless communication performed by a UE. The method may include determining whether a PSFCH transmission is scheduled during a COT. The method may include transmitting the PSFCH transmission according to a set of hybrid automatic repeat request (HARQ) timelines based at least in part on determining that the PSFCH transmission is scheduled outside the COT, or transmitting the PSFCH transmission according to a subset of the set of HARQ timelines based at least in part on determining that the PSFCH transmission is scheduled in the COT.

Some aspects described herein relate to a method of wireless communication performed by a UE. The method may include monitoring a PSFCH according to a subset of a set of HARQ timelines that is associated with feedback received during a COT. The method may include monitoring the PSFCH according to remaining HARQ timelines in the set of HARQ timelines, that are associated with feedback received outside the COT, based at least in part on receiving no feedback on the PSFCH during the subset of HARQ timelines.

Some aspects described herein relate to an apparatus for wireless communications at a UE. The apparatus may include a processor, memory coupled with the processor, and instructions stored in the memory. The instructions may be executable by the processor to cause the apparatus to determine whether a PSFCH transmission is scheduled during a COT. The instructions may be executable by the processor to cause the apparatus to transmit the PSFCH transmission using a first set of resources based at least in part on determining that the PSFCH transmission is scheduled outside the COT, or transmit the PSFCH transmission using a second set of resources based at least in part on determining that the PSFCH transmission is scheduled in the COT.

Some aspects described herein relate to an apparatus for wireless communications at a UE. The apparatus may include a processor, memory coupled with the processor, and instructions stored in the memory. The instructions may be executable by the processor to cause the apparatus to monitor a PSFCH using a first set of resources that is associated with feedback received during a COT. Additionally, or alternatively, the instructions may be executable by the processor to cause the apparatus to monitor the PSFCH using a second set of resources that is associated with feedback received outside the COT.

Some aspects described herein relate to an apparatus for wireless communications at a UE. The apparatus may include a processor, memory coupled with the processor, and instructions stored in the memory. The instructions may be executable by the processor to cause the apparatus to determine whether a PSFCH transmission is scheduled during a COT. The instructions may be executable by the processor to cause the apparatus to transmit the PSFCH transmission according to a set of HARQ timelines based at least in part on determining that the PSFCH transmission is scheduled outside the COT, or transmit the PSFCH transmission according to a subset of the set of HARQ timelines based at least in part on determining that the PSFCH transmission is scheduled in the COT.

Some aspects described herein relate to an apparatus for wireless communications at a UE. The apparatus may include a processor, memory coupled with the processor, and instructions stored in the memory. The instructions may be executable by the processor to cause the apparatus to monitor a PSFCH according to a subset of a set of HARQ timelines that is associated with feedback received during a COT. The instructions may be executable by the processor to cause the apparatus to monitor the PSFCH according to remaining HARQ timelines in the set of HARQ timelines, that are associated with feedback received outside the COT, based at least in part on receiving no feedback on the PSFCH during the subset of HARQ timelines.

Some aspects described herein relate to a non-transitory computer-readable medium that stores a set of instructions for wireless communication by a UE. The set of instructions, when executed by one or more processors of the UE, may cause the UE to determine whether a PSFCH transmission is scheduled during a COT. The set of instructions, when executed by one or more processors of the UE, may cause the UE to transmit the PSFCH transmission using a first set of resources based at least in part on determining that the PSFCH transmission is scheduled outside the COT, or transmit the PSFCH transmission using a second set of resources based at least in part on determining that the PSFCH transmission is scheduled in the COT.

Some aspects described herein relate to a non-transitory computer-readable medium that stores a set of instructions for wireless communication by a UE. The set of instructions, when executed by one or more processors of the UE, may cause the UE to monitor a PSFCH using a first set of resources that is associated with feedback received during a COT. Additionally, or alternatively, the set of instructions, when executed by one or more processors of the UE, may cause the UE to monitor the PSFCH using a second set of resources that is associated with feedback received outside the COT.

Some aspects described herein relate to a non-transitory computer-readable medium that stores a set of instructions for wireless communication by a UE. The set of instructions, when executed by one or more processors of the UE, may cause the UE to determine whether a PSFCH transmission is scheduled during a COT. The set of instructions, when executed by one or more processors of the UE, may cause the UE to transmit the PSFCH transmission according to a set of HARQ timelines based at least in part on determining that the PSFCH transmission is scheduled outside the COT, or transmit the PSFCH transmission according to a subset of the set of HARQ timelines based at least in part on determining that the PSFCH transmission is scheduled in the COT.

Some aspects described herein relate to a non-transitory computer-readable medium that stores a set of instructions for wireless communication by a UE. The set of instructions, when executed by one or more processors of the UE, may cause the UE to monitor a PSFCH according to a subset of a set of HARQ timelines that is associated with feedback received during a COT. The set of instructions, when executed by one or more processors of the UE, may cause the UE to monitor the PSFCH according to remaining HARQ timelines in the set of HARQ timelines, that are associated with feedback received outside the COT, based at least in part on receiving no feedback on the PSFCH during the subset of HARQ timelines.

Some aspects described herein relate to an apparatus for wireless communication. The apparatus may include means for determining whether a PSFCH transmission is scheduled during a COT. The apparatus may include means for transmitting the PSFCH transmission using a first set of resources based at least in part on determining that the PSFCH transmission is scheduled outside the COT, or means for transmitting the PSFCH transmission using a second set of resources based at least in part on determining that the PSFCH transmission is scheduled in the COT.

Some aspects described herein relate to an apparatus for wireless communication. The apparatus may include means for monitoring a PSFCH using a first set of resources that is associated with feedback received during a COT. Additionally, or alternatively, the apparatus may include means for monitoring the PSFCH using a second set of resources that is associated with feedback received outside the COT.

Some aspects described herein relate to an apparatus for wireless communication. The apparatus may include means for determining whether a PSFCH transmission is scheduled during a COT. The apparatus may include means for transmitting the PSFCH transmission according to a set of HARQ timelines based at least in part on determining that the PSFCH transmission is scheduled outside the COT, or means for transmitting the PSFCH transmission according to a subset of the set of HARQ timelines based at least in part on determining that the PSFCH transmission is scheduled in the COT.

Some aspects described herein relate to an apparatus for wireless communication. The apparatus may include means for monitoring a PSFCH according to a subset of a set of HARQ timelines that is associated with feedback received during a COT. The apparatus may include means for monitoring the PSFCH according to remaining HARQ timelines in the set of HARQ timelines, that are associated with feedback received outside the COT, based at least in part on receiving no feedback on the PSFCH during the subset of HARQ timelines.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example associated with transmitting and receiving hybrid automatic request (HARQ) feedback during and outside a channel occupancy time (COT), in accordance with the present disclosure.

FIGS. 4A, 4B, and 4C are diagrams illustrating examples associated with transmitting and receiving HARQ feedback during a COT, in accordance with the present disclosure.

FIGS. 5A, 5B, and 5C are diagrams illustrating examples associated with transmitting and receiving HARQ feedback during a COT, in accordance with the present disclosure.

FIGS. 6A and 6B are diagrams illustrating examples associated with HARQ timelines associated with a COT, in accordance with the present disclosure.

FIGS. 7, 8, 9, and 10 are diagrams illustrating example processes associated with transmitting and receiving HARQ feedback during a COT, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

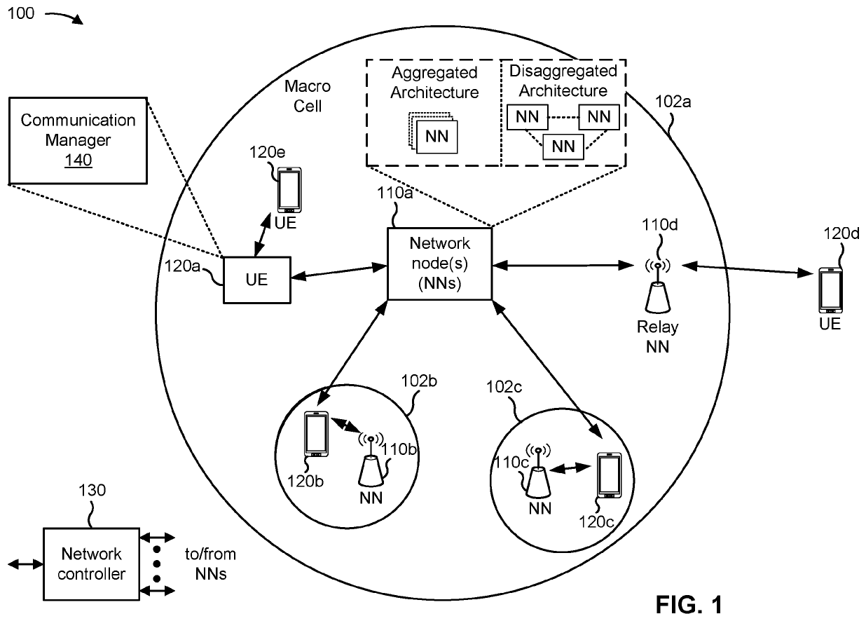

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. The UE 120 may transmit feedback on a sidelink channel. Accordingly, as described in more detail elsewhere herein, the communication manager 140 may determine whether a physical sidelink feedback channel (PSFCH) transmission is scheduled during a channel occupancy time (COT) and may transmit the PSFCH transmission using a first set of resources based at least in part on determining that the PSFCH transmission is scheduled outside the COT or transmit the PSFCH transmission using a second set of resources based at least in part on determining that the PSFCH transmission is scheduled in the COT. Alternatively, the communication manager 140 may determine whether a PSFCH transmission is scheduled during a COT and may transmit the PSFCH transmission according to a set of hybrid automatic repeat request (HARQ) timelines based at least in part on determining that the PSFCH transmission is scheduled outside the COT or transmit the PSFCH transmission according to a subset of the set of HARQ timelines based at least in part on determining that the PSFCH transmission is scheduled in the COT. Additionally, or alternatively, the communication manager 140 may perform one or more other operations described herein.

Alternatively, the UE 120 may receive feedback on the sidelink channel. Accordingly, as described in more detail elsewhere herein, the communication manager 140 may monitor a PSFCH using a first set of resources that is associated with feedback received during a COT and/or may monitor the PSFCH using a second set of resources that is associated with feedback received outside the COT. Alternatively, the communication manager 140 may monitor a PSFCH according to a subset of a set of HARQ timelines that is associated with feedback received during a COT and may monitor the PSFCH according to remaining HARQ timelines in the set of HARQ timelines, that are associated with feedback received outside the COT, based at least in part on receiving no feedback on the PSFCH during the subset of HARQ timelines. Additionally, or alternatively, the communication manager 140 may perform one or more other operations described herein.

As indicated above, FIG. 1 is provided as an example. Other examples may differ from what is described with regard to FIG. 1.

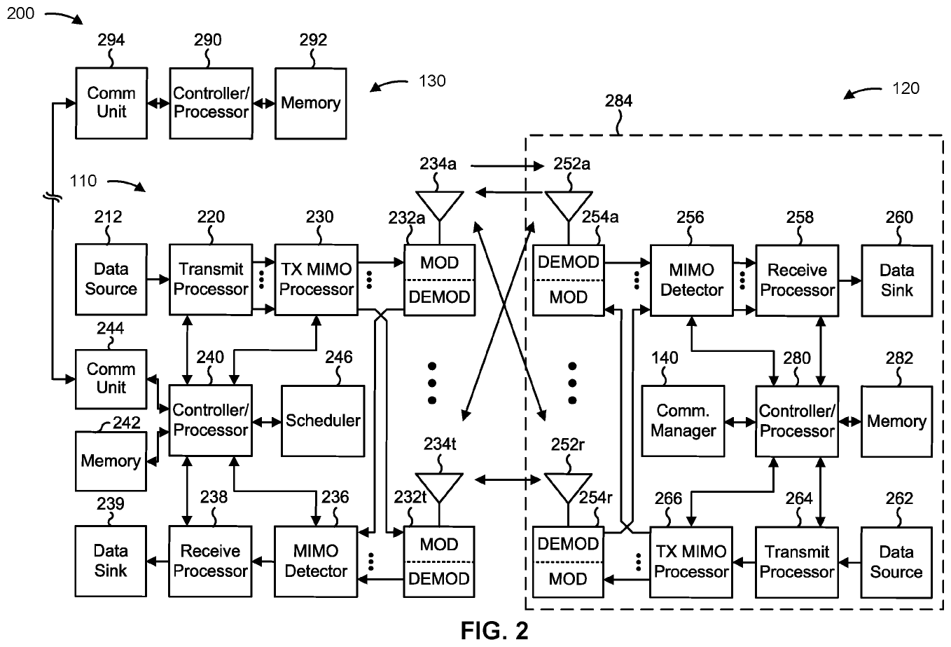

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

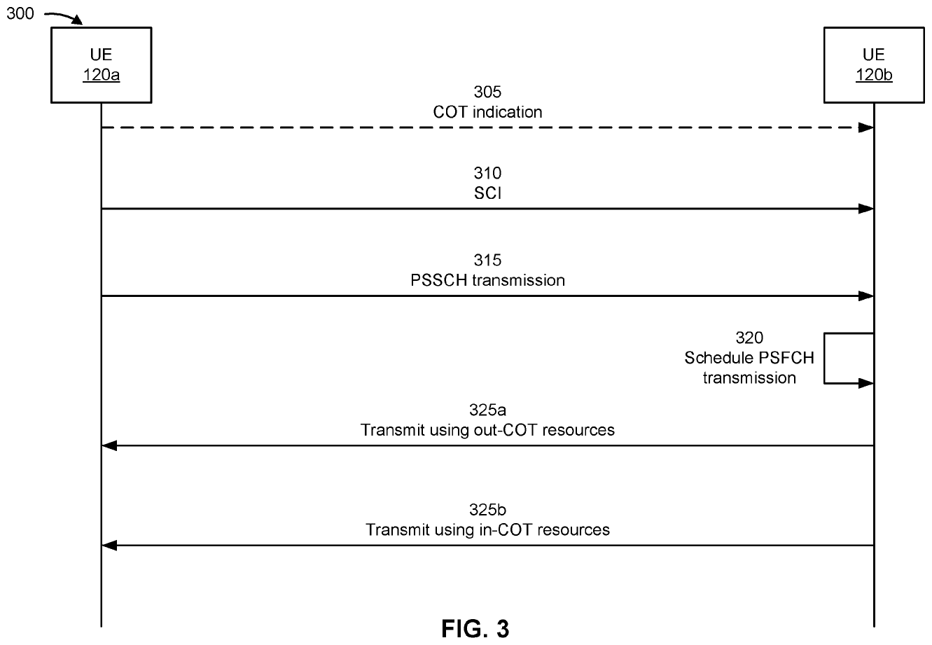

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-11).

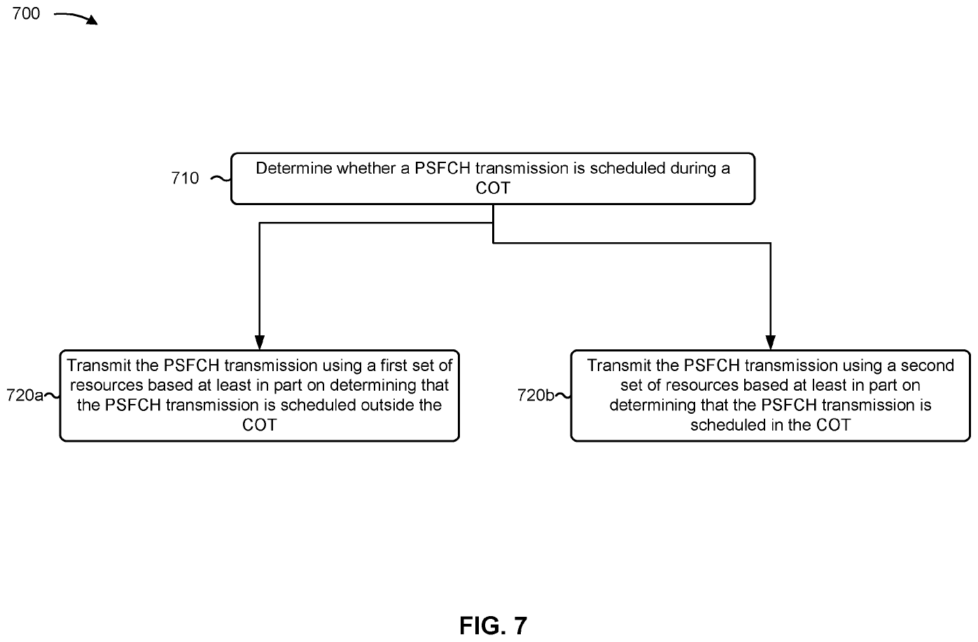

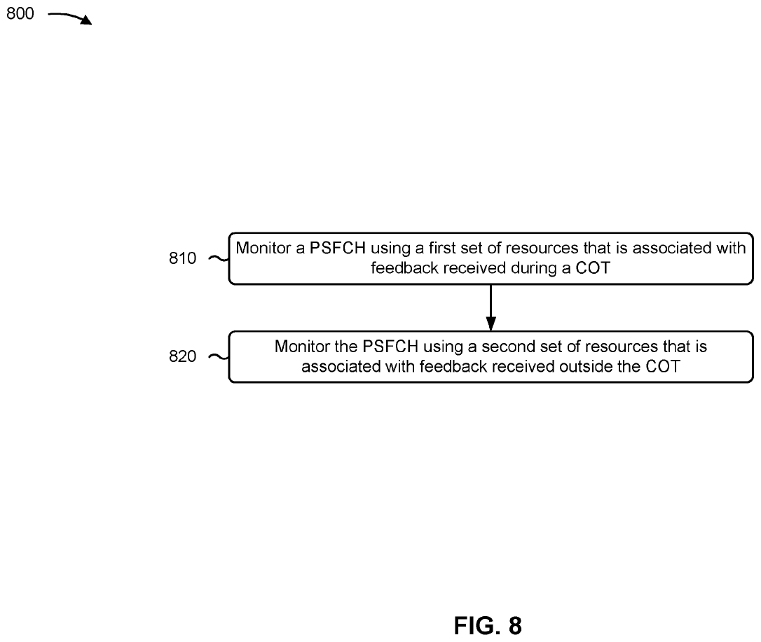

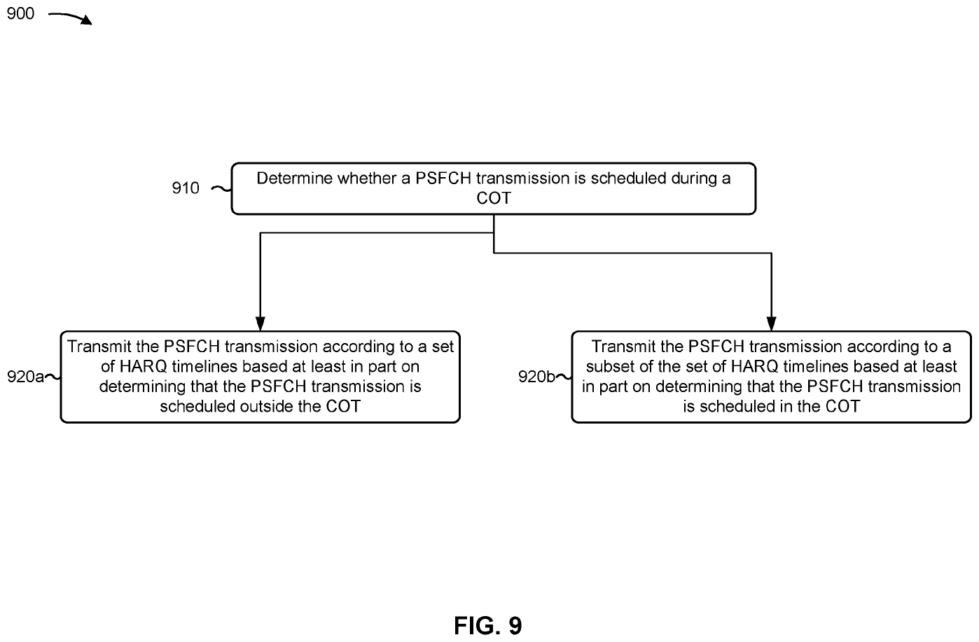

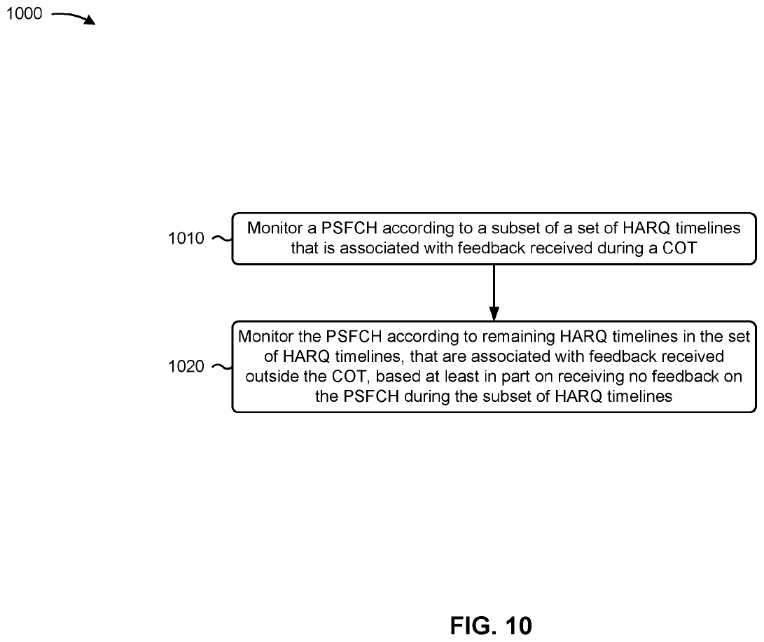

The controller/processor 240 of the network node 110, the controller/processor 280 of the UE 120, and/or any other component(s) of FIG. 2 may perform one or more techniques associated with transmitting and receiving HARQ feedback during and outside COT, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

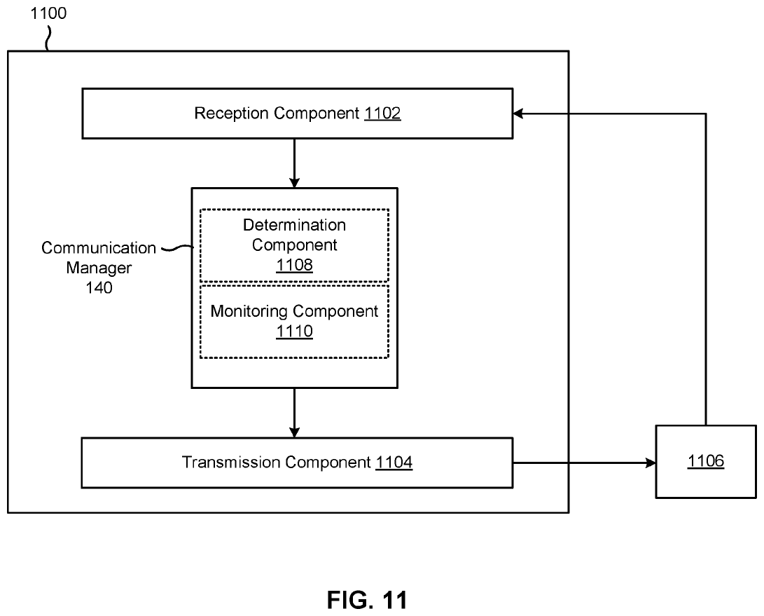

In some aspects, a UE (e.g., the UE 120 and/or apparatus 1100 of FIG. 11) may include means for determining whether a PSFCH transmission is scheduled during a COT; means for transmitting the PSFCH transmission using a first set of resources based at least in part on determining that the PSFCH transmission is scheduled outside the COT; and/or means for transmitting the PSFCH transmission using a second set of resources based at least in part on determining that the PSFCH transmission is scheduled in the COT. Alternatively, the UE may include means for determining whether a PSFCH transmission is scheduled during a COT; means for transmitting the PSFCH transmission according to a set of HARQ timelines based at least in part on determining that the PSFCH transmission is scheduled outside the COT; and/or or means for transmitting the PSFCH transmission according to a subset of the set of HARQ timelines based at least in part on determining that the PSFCH transmission is scheduled in the COT. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE may include means for monitoring a PSFCH using a first set of resources that is associated with feedback received during a COT; and/or means for monitoring the PSFCH using a second set of resources that is associated with feedback received outside the COT. Alternatively, the UE may include means for monitoring a PSFCH according to a subset of a set of HARQ timelines that is associated with feedback received during a COT; and/or means for monitoring the PSFCH according to remaining HARQ timelines in the set of HARQ timelines, that are associated with feedback received outside the COT, based at least in part on receiving no feedback on the PSFCH during the subset of HARQ timelines. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In unlicensed wireless frequencies, devices may perform listen-before-talk (LBT) before transmitting on the frequencies. In LBT, a device performs sensing (e.g., carrier sensing and energy detection (CS/ED), carrier sensing multiple access (CSMA), clear channel assessment (CCA), and/or another type of sensing) and transmits only when results from the sensing satisfy one or more conditions. In Type 1 channel access (also referred to as “category 4 LBT” or “CAT 4 LBT”), a time duration for the sensing is randomly (or at least pseudo-randomly) selected. In Type 2 channel access, a time duration for the sensing is preconfigured. For example, in Type 2A channel access, the time duration is 25 μs, and in Type 2B channel access, the time duration is 16 μs. Type 2A and Type 2B channel access are also referred to as “category 2 LBT” or “CAT 2 LBT.” In Type 2C channel access (also referred to as “category 1 LBT” or “CAT 1 LBT”), the time duration is 0 μs (that is, no sensing is performed).

When UEs communicate on a sidelink channel, a transmitting (Tx) UE may transmit data to a receiving (Rx) UE over a physical sidelink shared channel (PSSCH). Accordingly, the Rx UE transmits feedback (e.g., HARQ feedback, including acknowledgement (ACK) signals and negative-acknowledgement (NACK) signals) to the Tx UE over a PSFCH.

After performing LBT, a network device (such as a gNB, a UE, or another type of wireless device) may establish a COT during which the network device may transmit. The network device may share this COT with other network devices by transmitting COT structure information (COT-SI). Accordingly, HARQ feedback over a PSFCH may be scheduled during a COT or outside a COT.

Some techniques and apparatuses described herein enable configuration of different resource sets for PSFCH transmissions during a COT as compared with PSFCH transmissions outside a COT. As a result, a smaller resource set may be configured for PSFCH transmissions during a COT, which reduces power and processing resource waste for a UE (e.g., UE 120a) monitoring for the feedback. Similarly, a larger resource set may be configured for PSFCH transmissions outside a COT, which increases reliability and quality at the UE 120a. Additionally, or alternatively, a larger periodicity and/or offset may be configured for PSFCH transmissions during a COT, which reduces chances of interruption of the COT for the COT-initiator UE. Similarly, a shorter periodicity and/or offset may be configured for PSFCH transmissions outside a COT, which reduces latency and increases reliability and quality.

Alternatively, some techniques and apparatuses described herein enable configuration of different HARQ timelines for PSFCH transmissions during a COT as compared with PSFCH transmissions outside a COT. As a result, a smaller set of timelines may be configured for PSFCH transmissions during a COT, which reduces power and processing resource waste for a UE (e.g., UE 120a) monitoring for the feedback. Similarly, a larger set of timelines may be configured for PSFCH transmissions outside a COT, which increases reliability and quality at the UE 120a. Additionally, or alternatively, longer timelines may be configured for PSFCH transmissions during a COT, which reduces chances of interruption of the COT for the COT-initiator UE. Similarly, shorter timelines may be configured for PSFCH transmissions outside a COT, which increases reliability and quality.

FIG. 3 is a diagram illustrating an example 300 associated with transmitting and receiving HARQ feedback during and outside a COT, in accordance with the present disclosure. As shown in FIG. 3, a first UE 120a and a second UE 120b may communicate with one another (e.g., on a sidelink channel). The first UE 120a and the second UE 120b may use an unlicensed band or another set of frequencies that require LBT.

As shown by reference number 305, the UE 120a may initiate a COT and transmit (e.g., to the UE 120b) an indication of the COT. For example, the UE 120a may transmit COT-SI to the UE 120b. Accordingly, the UE 120a may be a COT-initiator UE.

Alternatively, the UE 120a may not be a COT-initiator UE such that the UE 120b receives COT-SI from another UE (not shown). Alternatively, the UE 120b may not receive COT-SI at all.

Furthermore, as shown by reference number 310, the UE 120a may transmit, and the UE 120b may receive, sidelink control information (SCI) that schedules a data transmission from the UE 120a to the UE 120b (e.g., over a PSSCH). In some aspects, the SCI may comprise stage 1 SCI (SCI-1) followed by stage 2 SCI (SCI-2).

Accordingly, as shown by reference number 315, the UE 120a may transmit, and the UE 120b may receive, the data transmission (e.g., over the PSSCH). The UE 120a may transmit the data transmission, and the UE 120b may monitor for the data transmission, according to the SCI (e.g., using time, frequency, and/or spatial resources indicated in the SCI).

Therefore, the UE 120b may generate HARQ feedback based on whether the data transmission was successfully received and decoded. In some aspects, the HARQ feedback may include a single ACK signal or NACK signal associated with the data transmission. Alternatively, the UE 120b may generate HARQ feedback that includes a plurality of signals associated with a plurality of data transmissions from the UE 120a.

As shown by reference number 320, the UE 120b may determine whether a PSFCH transmission is scheduled during a COT. For example, the PSFCH transmission may include the HARQ feedback. In some aspects, the UE 120b may determine whether the PSFCH transmission is within the COT by comparing a minimum time gap associated with the PSFCH transmission (e.g., set by a MinTimeGapPSFCH data element, as described in 3GPP specifications and/or another standard) with a duration for the COT (e.g., as indicated in COT-SI from the UE 120a or another UE). When the UE 120b has not received COT-SI, the UE 120b determines that the PSFCH transmission is not scheduled during a COT.

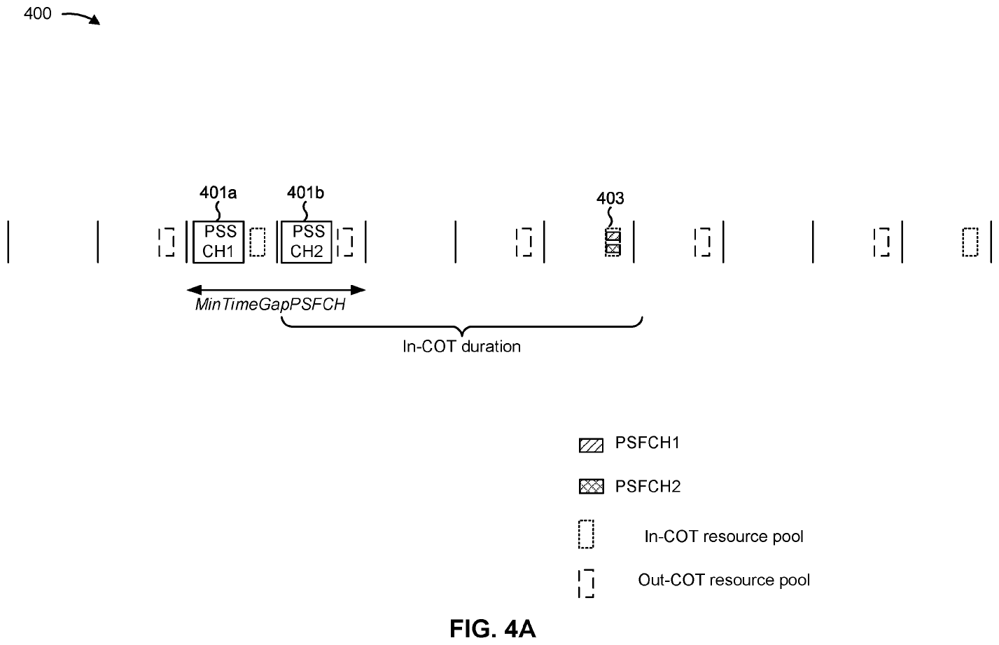

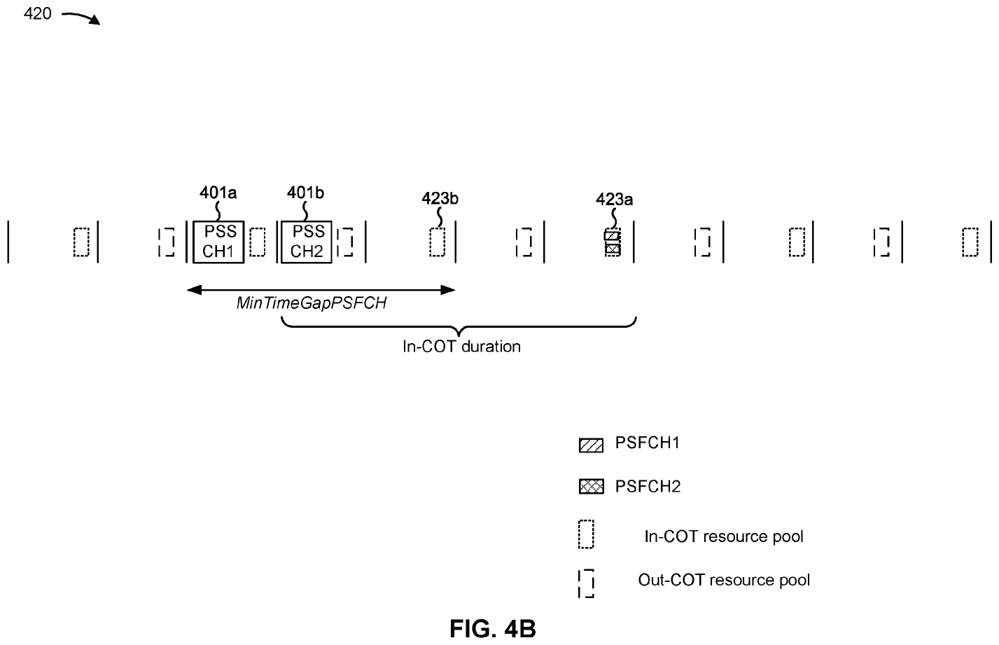

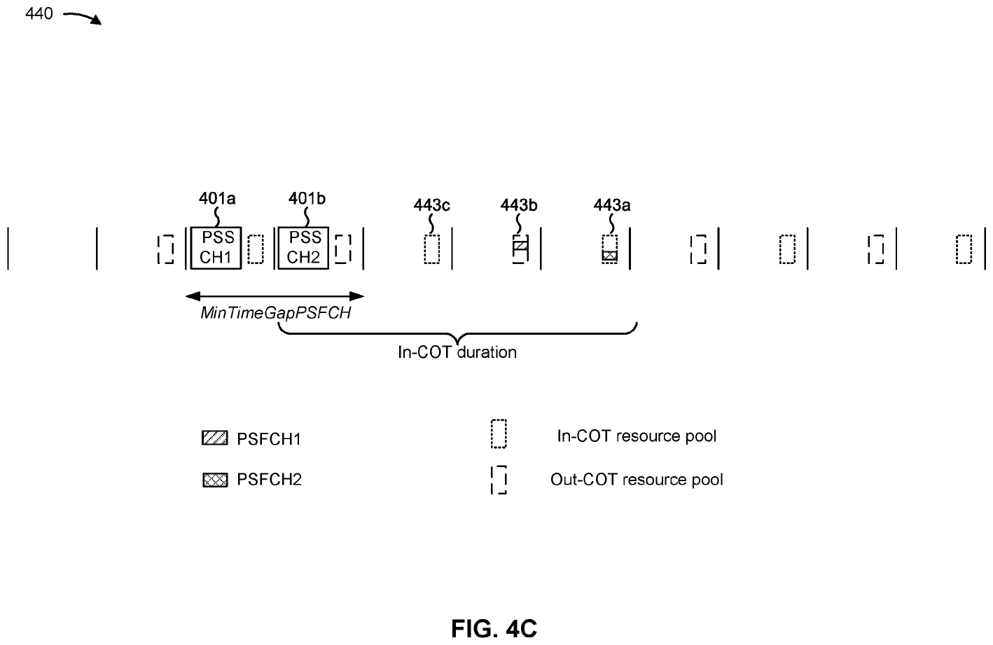

Accordingly, as shown by reference number 325a, the UE 120b may transmit the PSFCH transmission using a first set of resources (also referred to as “out-COT resources”) based at least in part on determining that the PSFCH transmission is scheduled outside a COT. In some aspects, as described in connection with FIG. 4C, the UE 120b may use the first set of resources as a fallback when the second set of resources cannot be used. Further, the UE 120b may transmit the PSFCH according to a first set of HARQ timelines that is associated with the first set of resources.

As shown by reference number 325b, the UE 120b may transmit the PSFCH transmission using a second set of resources (also referred to as “in-COT resources”) based at least in part on determining that the PSFCH transmission is scheduled during a COT. As described in connection with FIG. 4A, the UE 120b may use the same occasion (when feasible) for all PSFCH transmissions scheduled inside the COT.

In some aspects, the UE 120b may select any (in time) occasion in the second set of resources when the UE 120a is a COT-initiator UE but select a latest (in time) occasion in the second set of resources when the UE 120a is a node that is not associated with the COT, as described in connection with FIG. 4B. In some aspects, the UE 120b may select the occasion, in the second set of resources, that was indicated in COT-SI and/or SCI by the UE 120a when the UE 120a is a COT-initiator UE. Alternatively, the UE 120b may use all the occasions in the second set of resources to both COT-initiator UEs and to other UEs. Further, the UE 120b may transmit the PSFCH according to a second set of HARQ timelines that is associated with the second set of resources.

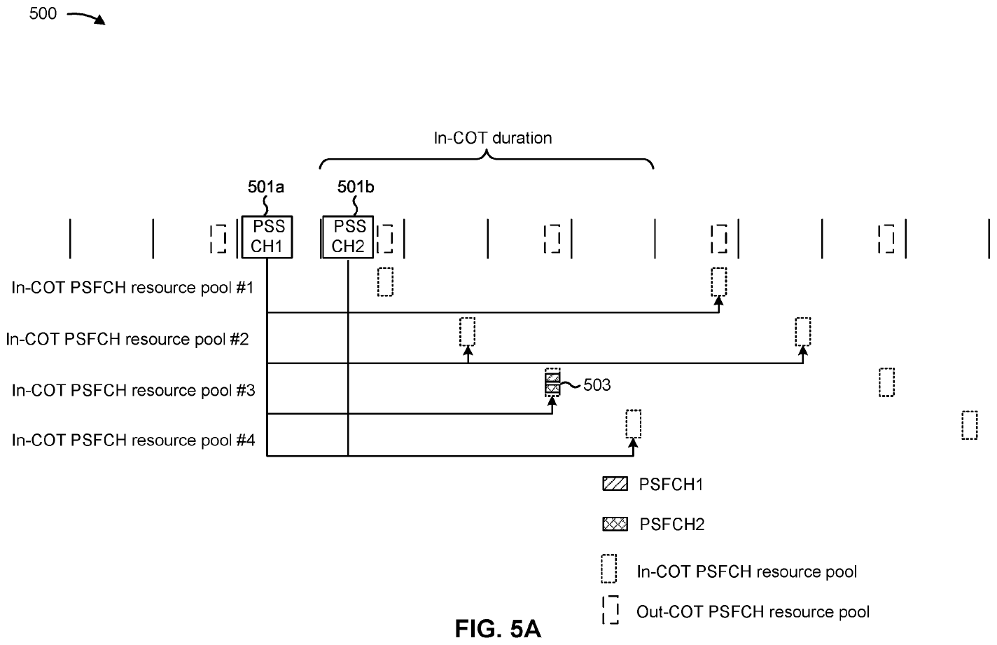

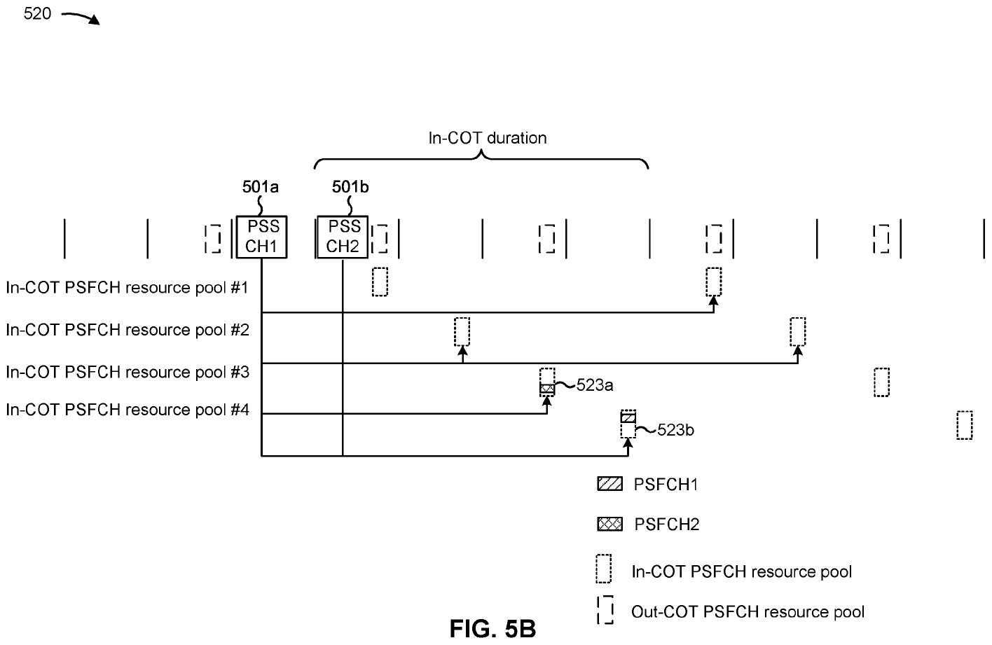

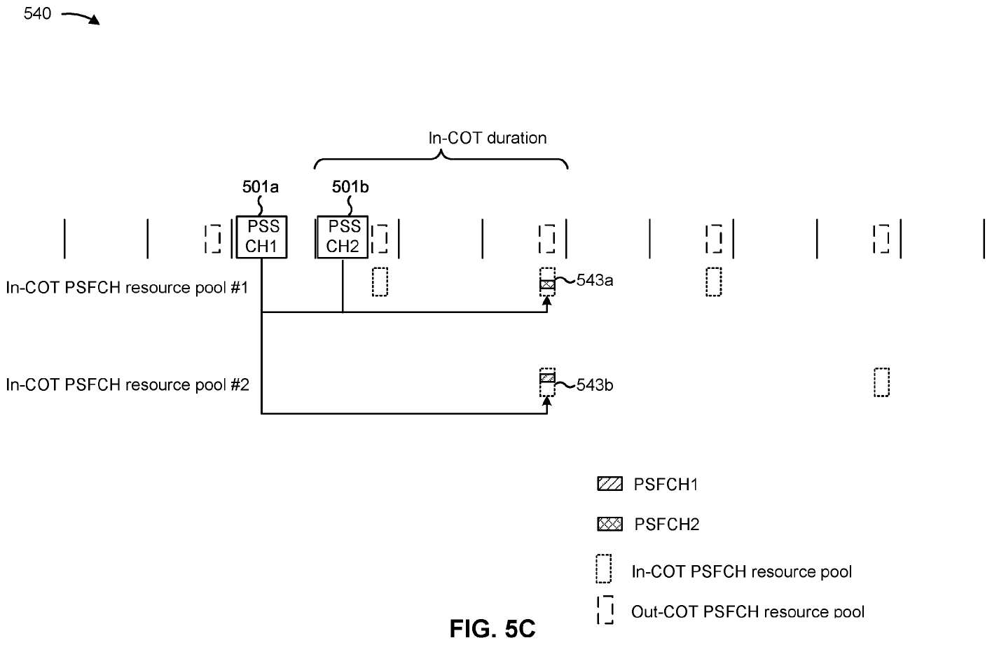

In some aspects, the second set of resources may comprise a plurality of resource pools. In some aspects, the UE 120b may select any resource pool in the plurality of resource pools when the UE 120a is a COT-initiator UE but select the resource pool with a latest (in time) occasion at the end of the COT when the UE 120a is a node that is not associated with the COT, as described in connection with FIG. 5B. When multiple occasions are the latest, the UE 120b may select a resource pool with a longest periodicity, as described in connection with FIG. 5C. In some aspects, the UE 120b may select the resource pool, in the plurality of resource pools, that was indicated in COT-SI and/or SCI by the UE 120a when the UE 120a is a COT-initiator UE. Alternatively, the UE 120b may use the resource pool that was indicated in COT-SI and/or SCI for PSFCH transmissions to both COT-initiator UEs and to other UEs, as described in connection with FIG. 5A.

The first set of resources is associated with a first periodicity and a first offset, and the second set of resources is associated with a second periodicity and a second offset. Accordingly, in some aspects, the second periodicity is longer than the first periodicity, and/or the second offset is longer than the first offset.

When the UE 120a is a COT-initiator UE, the UE 120a may monitor the PSFCH using the second set of resources because the UE 120a is aware that the PSFCH transmission is during the COT. Alternatively, when the UE 120a is not a COT-initiator UE, the UE 120 may monitor the PSFCH using the first set of resources in combination with the second set of resources because the UE 120a is unaware whether the PSFCH transmission is during a COT. Further, the UE 120a may assume the data transmission was received when an ACK signal is received in at least one occasion within the second set of resources. Similarly, the UE 120a may assume the data transmission was not received when no ACK signal is received in all occasions within the second set of resources.

By using techniques as described in connection with FIG. 3, the UE 120b uses different resource sets for PSFCH transmissions during a COT as compared with PSFCH transmissions outside a COT. As a result, the second resource set may be smaller than the first resource set, which reduces power and processing resource waste at the UE 120a. Similarly, the first resource set may be larger than the second resource set, which increases reliability and quality at the UE 120a. Additionally, or alternatively, the second resource set may have a larger periodicity and/or offset than the first resource set, which reduces chances of interruption of the COT for the COT-initiator UE. Similarly, the first resource set may have a shorter periodicity and/or offset than the second resource set, which increases reliability and quality at the UE 120a.

As indicated above, FIG. 3 is provided as an example. Other examples may differ from what is described with respect to FIG. 3.

FIG. 4A is a diagram illustrating an example 400 associated with transmitting and receiving HARQ feedback during a COT, in accordance with the present disclosure. As shown in FIG. 4A, example 400 includes a data transmission 401a (shown as “PSSCH1”) from a Tx UE and a data transmission 401b (shown as “PSSCH2”) from a COT-initiator UE. Accordingly, an Rx UE schedules a PSFCH transmission to the Tx UE (shown as “PSFCH1”) associated with the data transmission 401a and a PSFCH transmission to the COT-initiator UE (shown as “PSFCH2”) associated with the data transmission 401b.

As shown in FIG. 4A, the Rx UE may transmit all PSFCH transmissions within a same occasion 403 in an in-COT resource pool. For example, occasion 403 is a PSFCH occasion in an in-COT resource pool, and for both PSSCH1 and PSSCH2, and occasion 403 is the earliest occasion in the in-COT resource pool that satisfies a minimum time gap (e.g., MinTimeGapPSFCH, as shown in FIG. 4A). Alternatively, the Rx UE may schedule the PSFCH transmissions within a latest occasion in the in-COT resource pool.

FIG. 4B is a diagram illustrating an example 420 associated with transmitting and receiving HARQ feedback during a COT, in accordance with the present disclosure. As shown in FIG. 4B, example 420 includes a data transmission 401a (shown as “PSSCH1”) from a Tx UE and a data transmission 401b (shown as “PSSCH2”) from a COT-initiator UE. Accordingly, an Rx UE schedules a PSFCH transmission to the Tx UE (shown as “PSFCH1”) associated with the data transmission 401a and a PSFCH transmission to the COT-initiator UE (shown as “PSFCH2”) associated with the data transmission 401b.

As shown in FIG. 4B, the Rx UE may transmit PSFCH transmissions to the COT-initiator UE within an occasion 423a in an in-COT resource pool. For example, within the COT, occasion 423a and occasion 423b are in the in-COT resource pool. For the COT-initiator UE, either occasion 423a or occasion 423b may be used. For PSSCH2, the occasion 423a may be an earliest occasion in the in-COT resource pool that satisfies a minimum time gap MinTimeGapPSFCH, and SCI that schedules PSSCH2 may indicate that PSFCH2 can be transmitted in the in-COT resource pool, such that the Rx UE transmits PSFCH2 in the occasion 423a. Moreover, the Rx UE may transmit PSFCH1 to the Tx UE within the occasion 423a in the in-COT resource pool. For PSSCH1, the occasion 423a may be an earliest occasion in the in-COT resource pool that satisfies a minimum time gap MinTimeGapPSFCH. The Rx UE may select the occasion 423a because the occasion 423a is the latest occasion in the in-COT resource pool. Accordingly, the Rx UE is less likely to interrupt a transmission from the COT-initiator UE during the COT.

FIG. 4C is a diagram illustrating an example 440 associated with transmitting and receiving HARQ feedback during a COT, in accordance with the present disclosure. As shown in FIG. 4C, example 440 includes a data transmission 401a (shown as “PSSCH1”) from a Tx UE and a data transmission 401b (shown as “PSSCH2”) from a COT-initiator UE. Accordingly, an Rx UE schedules a PSFCH transmission to the Tx UE (shown as “PSFCH1”) associated with the data transmission 401a and a PSFCH transmission to the COT-initiator UE (shown as “PSFCH2”) associated with the data transmission 401b.

As shown in FIG. 4C, the Rx UE may transmit PSFCH2 to the COT-initiator UE within an occasion 443a in an in-COT resource pool. For example, within the COT, occasion 443a and occasion 443c are in the in-COT resource pool. For the COT-initiator UE, either occasion 443a or occasion 443c can be used. For PSSCH2, the occasion 443a may be an earliest occasion that satisfies a minimum time gap MinTimeGapPSFCH, and SCI that schedules PSSCH2 may indicate that PSFCH2 may be transmitted in the in-COT resource pool, such that the Rx UE may transmit PSFCH2 in the occasion 443a. However, when the SCI that schedules PSSCH2 indicates that the PSFCH2 cannot be transmitted in the in-COT resource pool, the PSFCH2 may be transmitted in occasion 443b, which is an earliest occasion that satisfies a minimum time gap in an out-COT resource pool. Accordingly, the Rx UE may transmit PSFCH1 to a Tx UE within the occasion 443b in the out-COT resource pool. For example, when the Tx UE is not a COT initiator, only the latest occasion (e.g., occasion 443a in example 440) in the COT may be used for PSFCH transmissions. Accordingly, when the Rx UE cannot bundle a PSFCH transmission to the Tx UE in the occasion 443a, the Rx UE may fall back to the out-COT resource pool and select occasion 443b therein. The Rx UE may select the occasion 443b because the occasion 443b is an earliest occasion that satisfies a minimum time gap MinTimeGapPSFCH in the out-COT resource pool. Because the Tx UE is not aware of the COT, the Rx UE can fall back to the out-COT resource pool because the Tx UE will monitor both pools, as described in connection with FIG. 3.

As indicated above, FIGS. 4A-4C are provided as examples. Other examples may differ from what is described with respect to FIGS. 4A-4C.

FIG. 5A is a diagram illustrating an example 500 associated with transmitting and receiving HARQ feedback during a COT, in accordance with the present disclosure. As shown in FIG. 5A, example 500 includes a data transmission 501a (shown as “PSSCH1”) from a Tx UE and a data transmission 501b (shown as “PSSCH2”) from a COT-initiator UE. Accordingly, an Rx UE schedules a PSFCH transmission to the Tx UE (shown as “PSFCH1”) associated with the data transmission 501a and a PSFCH transmission to the COT-initiator UE (shown as “PSFCH2”) associated with the data transmission 501b.

In example 500, a set of in-COT resources includes four resource pools. Although described using four resource pools, other examples may include fewer pools (e.g., three pools or two pools) or additional pools (e.g., five pools, six pools, and so on). The resource pools in example 500 have different offsets but the same periodicities. Other examples may include at least two resource pools with different periodicities and/or a same offset.

As shown in FIG. 5A, the Rx UE may transmit all PSFCH transmissions within a same occasion 503 in an in-COT resource pool. For example, the Rx UE may schedule the PSFCH transmissions within an occasion in the in-COT resource pool indicated by COT-SI and/or SCI from the COT-initiator UE.

FIG. 5B is a diagram illustrating an example 520 associated with transmitting and receiving HARQ feedback during a COT, in accordance with the present disclosure. As shown in FIG. 5B, example 520 includes a data transmission 501a (shown as “PSSCH1”) from a Tx UE and a data transmission 501b (shown as “PSSCH2”) from a COT-initiator UE. Accordingly, an Rx UE schedules a PSFCH transmission to the Tx UE (shown as “PSFCH1”) associated with the data transmission 501a and a PSFCH transmission to the COT-initiator UE (shown as “PSFCH2”) associated with the data transmission 501b.

In example 520, a set of in-COT resources includes four resource pools. Although described using four resource pools, other examples may include fewer pools (e.g., three pools or two pools) or additional pools (e.g., five pools, six pools, and so on). The resource pools in example 520 have different offsets but the same periodicities. Other examples may include at least two resource pools with different periodicities and/or a same offset.

As shown in FIG. 5B, the Rx UE may transmit PSFCH transmissions to the COT-initiator UE within an occasion 523a in an in-COT resource pool. For example, the occasion 523a may be indicated by the COT-initiator UE in COT-SI and/or SCI. Moreover, the Rx UE may transmit PSFCH transmissions to the Tx UE within an occasion 523b in the in-COT resource pool. The Rx UE may select the occasion 523b because the occasion 523b is the latest occasion in the in-COT resource pool. Accordingly, the Rx UE is less likely to interrupt a transmission from the COT-initiator UE during the COT.

FIG. 5C is a diagram illustrating an example 540 associated with transmitting and receiving HARQ feedback during a COT, in accordance with the present disclosure. As shown in FIG. 5C, example 540 includes a data transmission 501a (shown as “PSSCH1”) from a Tx UE and a data transmission 501b (shown as “PSSCH2”) from a COT-initiator UE. Accordingly, an Rx UE schedules a PSFCH transmission to the Tx UE (shown as “PSFCH1”) associated with the data transmission 501a and a PSFCH transmission to the COT-initiator UE (shown as “PSFCH2”) associated with the data transmission 501b.

In example 540, a set of in-COT resources includes two resource pools. Although described using two resource pools, other examples may include additional pools (e.g., three pools, four pools, and so on). The resource pools in example 540 have a same offset but different periodicities. Other examples may include at least two resource pools with different offsets and/or a same periodicity.

As shown in FIG. 5C, the Rx UE may transmit PSFCH transmissions to the COT-initiator UE within an occasion 543a in an in-COT resource pool. For example, the occasion 543a may be indicated by the COT-initiator UE in COT-SI and/or SCI. Moreover, the Rx UE may transmit PSFCH transmissions to the Tx UE within an occasion 543b in the in-COT resource pool. The Rx UE may select the occasion 543b because the occasion 543b is associated with the pool that has the longest periodicity of the pools that include a latest occasion at the end of the COT. Accordingly, the Rx UE is less likely to interrupt a transmission from the COT-initiator UE during the COT.

As indicated above, FIGS. 5A-5C are provided as examples. Other examples may differ from what is described with respect to FIGS. 5A-5C.

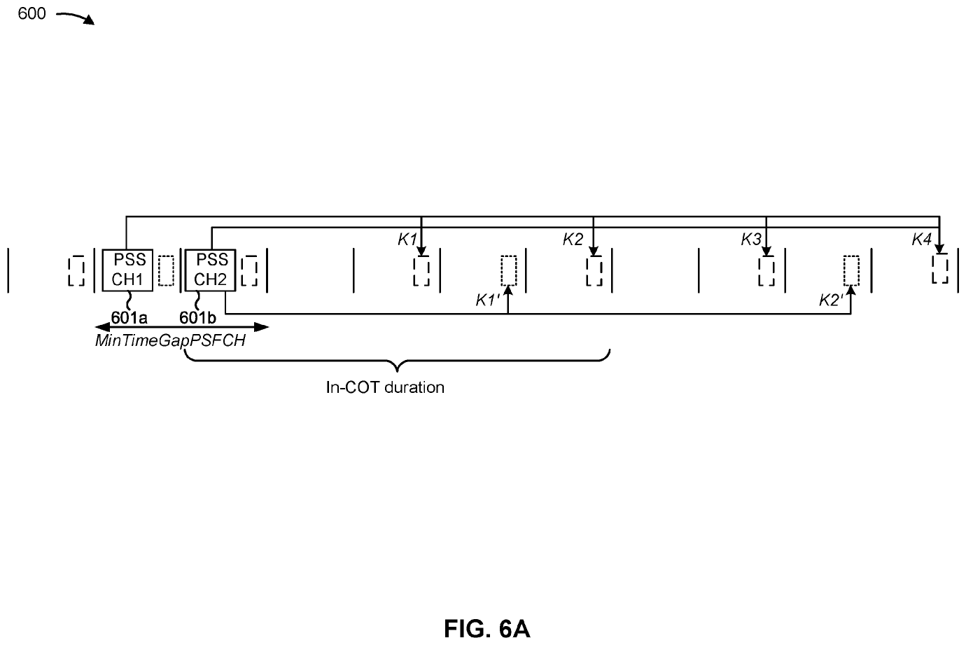

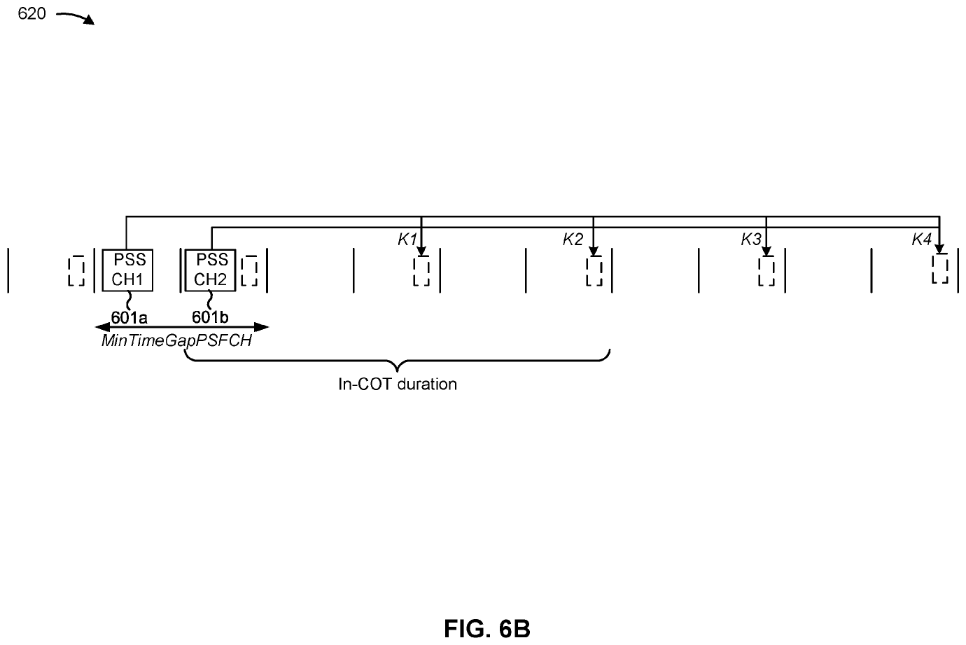

FIG. 6A is a diagram illustrating an example 600 associated with HARQ timelines associated with a COT, in accordance with the present disclosure. As shown in FIG. 6A, example 600 includes a data transmission 601a (shown as “PSSCH1”) from a Tx UE and a data transmission 601b (shown as “PSSCH2”) from a COT-initiator UE. Accordingly, an Rx UE schedules a PSFCH transmission to the Tx UE associated with the data transmission 601a and a PSFCH transmission to the COT-initiator UE associated with the data transmission 601b.

As shown in FIG. 6A, a first set of HARQ timelines (represented by K1, K2, K3, and K4 in example 600) are associated with out-COT PSFCH transmissions. Accordingly, the Rx UE may select from the first set of HARQ timelines when transmitting HARQ feedback outside a COT (or as a fallback within the COT to the Tx UE, as described in connection with FIG. 4C). Similarly, a second set of HARQ timelines (represented by K1′ and K2′ in example 600) are associated with in-COT PSFCH transmissions. Accordingly, the Rx UE may select from the second set of HARQ timelines when transmitting HARQ feedback inside a COT.

FIG. 6B is a diagram illustrating an example 620 associated with HARQ timelines associated with a COT, in accordance with the present disclosure. As shown in FIG. 6B, example 620 includes a data transmission 601a (shown as “PSSCH1”) from a Tx UE and a data transmission 601b (shown as “PSSCH2”) from a COT-initiator UE. Accordingly, an Rx UE schedules a PSFCH transmission to the Tx UE associated with the data transmission 601a and a PSFCH transmission to the COT-initiator UE associated with the data transmission 601b.

In example 620, the Rx UE uses a same set of resources (and thus a same resource pool) for in-COT PSFCH transmissions and out-COT PSFCH transmissions. Further, as shown in FIG. 6B, a set of HARQ timelines (represented by K1, K2, K3, and K4 in example 620) are associated with out-COT PSFCH transmissions. Accordingly, the Rx UE may select from the first set of HARQ timelines when transmitting HARQ feedback outside a COT. Moreover, a subset of the set of HARQ timelines (e.g., K1 and K2 in example 620) are associated with in-COT PSFCH transmissions.

Accordingly, the Rx UE may select from the subset of HARQ timelines when transmitting HARQ feedback inside a COT.

As indicated above, FIGS. 6A-6B are provided as examples. Other examples may differ from what is described with respect to FIGS. 6A-6B.

FIG. 7 is a diagram illustrating an example process 700 performed, for example, by a UE, in accordance with the present disclosure. Example process 700 is an example where the UE (e.g., UE 120 and/or apparatus 1100 of FIG. 11) performs operations associated with transmitting HARQ feedback during and outside COT.

As shown in FIG. 7, in some aspects, process 700 may include determining whether a PSFCH transmission is scheduled during a COT (block 710). For example, the UE (e.g., using communication manager 140 and/or determination component 1108, depicted in FIG. 11) may determine whether a PSFCH transmission is scheduled during a COT, as described herein.

As further shown in FIG. 7, in some aspects, process 700 may include transmitting the PSFCH transmission using a first set of resources based at least in part on determining that the PSFCH transmission is scheduled outside the COT (block 720a). For example, the UE (e.g., using communication manager 140 and/or transmission component 1104, depicted in FIG. 11) may transmit the PSFCH transmission using a first set of resources based at least in part on determining that the PSFCH transmission is scheduled outside the COT, as described herein. Alternatively, process 700 may include transmitting the PSFCH transmission using a second set of resources based at least in part on determining that the PSFCH transmission is scheduled in the COT (block 720b). For example, the UE (e.g., using communication manager 140 and/or transmission component 1104) may transmit the PSFCH transmission using a second set of resources based at least in part on determining that the PSFCH transmission is scheduled in the COT, as described herein.

Process 700 may include additional aspects, such as any single aspect or any combination of aspects described below and/or in connection with one or more other processes described elsewhere herein.

In a first aspect, determining whether the PSFCH is scheduled during the COT includes receiving (e.g., using communication manager 140 and/or reception component 1102, depicted in FIG. 11) an indication of the COT.

In a second aspect, alone or in combination with the first aspect, the first set of resources is associated with a first periodicity and a first offset, and the second set of resources is associated with a second periodicity and a second offset.

In a third aspect, alone or in combination with one or more of the first and second aspects, the second periodicity is longer than the first periodicity.

In a fourth aspect, alone or in combination with one or more of the first through third aspects, the PSFCH transmission is for a COT-initiator node, and the PSFCH transmission is transmitted using the second set of resources.

In a fifth aspect, alone or in combination with one or more of the first through fourth aspects, the PSFCH transmission is for a node not associated with the COT, and the PSFCH transmission is transmitted using an instance in the second set of resources that is latest in time.

In a sixth aspect, alone or in combination with one or more of the first through fifth aspects, process 700 includes receiving (e.g., using communication manager 140 and/or reception component 1102) SCI indicating an instance in the second set of resources to use for the PSFCH transmission, where the PSFCH transmission is for a COT-initiator UE.

In a seventh aspect, alone or in combination with one or more of the first through sixth aspects, the second set of resources comprises a plurality of resource pools.

In an eighth aspect, alone or in combination with one or more of the first through seventh aspects, process 700 includes receiving (e.g., using communication manager 140 and/or reception component 1102) an indication of the COT indicating which resource pool, of the plurality of resource pools, to use for the PSFCH transmission.

In a ninth aspect, alone or in combination with one or more of the first through eighth aspects, process 700 includes receiving (e.g., using communication manager 140 and/or reception component 1102) SCI indicating which resource pool, of the plurality of resource pools, to use for the PSFCH transmission, where the PSFCH transmission is for a COT-initiator UE.

In a tenth aspect, alone or in combination with one or more of the first through ninth aspects, the PSFCH transmission is for a node not associated with the COT, and the PSFCH transmission is transmitted using a resource pool, in the plurality of resource pools, that has an instance latest in time.

In an eleventh aspect, alone or in combination with one or more of the first through tenth aspects, the first set of resources is associated with a first set of HARQ timelines, and the second set of resources is associated with a second set of HARQ timelines.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120 and/or apparatus 1100 of FIG. 11) performs operations associated with receiving HARQ feedback during and outside COT.

As shown in FIG. 8, in some aspects, process 800 may include monitoring a PSFCH using a first set of resources that is associated with feedback received during a COT (block 810). For example, the UE (e.g., using communication manager 140 and/or monitoring component 1110, depicted in FIG. 11) may monitor a PSFCH using a first set of resources that is associated with feedback received during a COT, as described herein.

As further shown in FIG. 8, in some aspects, process 800 may additionally or alternatively include monitoring the PSFCH using a second set of resources that is associated with feedback received outside the COT (block 820). For example, the UE (e.g., using communication manager 140 and/or monitoring component 1110) may monitor the PSFCH using a second set of resources that is associated with feedback received outside the COT, as described herein.

Process 800 may include additional aspects, such as any single aspect or any combination of aspects described below and/or in connection with one or more other processes described elsewhere herein.

In a first aspect, process 800 includes initiating the COT (e.g., using communication manager 140 and/or reception component 1102, depicted in FIG. 11) and transmitting (e.g., using communication manager 140 and/or transmission component 1104, depicted in FIG. 11) an indication of the COT.

In a second aspect, alone or in combination with the first aspect, the first set of resources is associated with a first periodicity and a first offset, and the second set of resources is associated with a second periodicity and a second offset.

In a third aspect, alone or in combination with one or more of the first and second aspects, the second periodicity is longer than the first periodicity.

In a fourth aspect, alone or in combination with one or more of the first through third aspects, process 800 includes transmitting (e.g., using communication manager 140 and/or transmission component 1104) SCI indicating an instance in the second set of resources to use, where the UE is a COT-initiator UE.

In a fifth aspect, alone or in combination with one or more of the first through fourth aspects, the second set of resources comprises a plurality of resource pools.

In a sixth aspect, alone or in combination with one or more of the first through fifth aspects, process 800 includes transmitting (e.g., using communication manager 140 and/or transmission component 1104) an indication of the COT indicating which resource pool, of the plurality of resource pools, to use.

In a seventh aspect, alone or in combination with one or more of the first through sixth aspects, process 800 includes transmitting (e.g., using communication manager 140 and/or transmission component 1104) SCI indicating which resource pool, of the plurality of resource pools, to use, where the UE is a COT-initiator UE.

In an eighth aspect, alone or in combination with one or more of the first through seventh aspects, the first set of resources is associated with a first set of HARQ timelines, and the second set of resources is associated with a second set of HARQ timelines.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120 and/or apparatus 1100 of FIG. 11) performs operations associated with receiving HARQ feedback during and outside COT.

As shown in FIG. 9, in some aspects, process 900 may include determining whether a PSFCH transmission is scheduled during a COT (block 910). For example, the UE (e.g., using communication manager 140 and/or determination component 1108, depicted in FIG. 11) may determine whether a PSFCH transmission is scheduled during a COT, as described herein.

As further shown in FIG. 9, in some aspects, process 900 may include transmitting the PSFCH transmission according to a set of HARQ timelines based at least in part on determining that the PSFCH transmission is scheduled outside the COT (block 920a). For example, the UE (e.g., using communication manager 140 and/or transmission component 1104, depicted in FIG. 11) may transmit the PSFCH transmission according to a set of HARQ timelines based at least in part on determining that the PSFCH transmission is scheduled outside the COT, as described herein. Alternatively, process 900 may include transmitting the PSFCH transmission according to a subset of the set of HARQ timelines based at least in part on determining that the PSFCH transmission is scheduled in the COT (block 920b). For example, the UE (e.g., using communication manager 140 and/or transmission component 1104) may transmit the PSFCH transmission according to a subset of the set of HARQ timelines based at least in part on determining that the PSFCH transmission is scheduled in the COT, as described herein.

Process 900 may include additional aspects, such as any single aspect or any combination of aspects described below and/or in connection with one or more other processes described elsewhere herein.

In a first aspect, the determining whether the PSFCH is scheduled during the

COT includes receiving (e.g., using communication manager 140 and/or reception component 1102, depicted in FIG. 11) an indication of the COT.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120 and/or apparatus 1100 of FIG. 11) performs operations associated with receiving HARQ feedback during and outside COT.

As shown in FIG. 10, in some aspects, process 1000 may include monitoring a PSFCH according to a subset of a set of HARQ timelines that is associated with feedback received during a COT (block 1010). For example, the UE (e.g., using communication manager 140 and/or monitoring component 1110, depicted in FIG. 11) may monitor a PSFCH according to a subset of a set of HARQ timelines that is associated with feedback received during a COT, as described herein.

As further shown in FIG. 10, in some aspects, process 1000 may include monitoring the PSFCH according to remaining HARQ timelines in the set of HARQ timelines, that are associated with feedback received outside the COT, based at least in part on receiving no feedback on the PSFCH during the subset of HARQ timelines (block 1020). For example, the UE (e.g., using communication manager 140 and/or monitoring component 1110) may monitor the PSFCH according to remaining HARQ timelines in the set of HARQ timelines, that are associated with feedback received outside the COT, based at least in part on receiving no feedback on the PSFCH during the subset of HARQ timelines, as described herein.

Process 1000 may include additional aspects, such as any single aspect or any combination of aspects described below and/or in connection with one or more other processes described elsewhere herein.

In a first aspect, process 1000 includes initiating the COT (e.g., using communication manager 140 and/or reception component 1102, depicted in FIG. 11) and transmitting (e.g., using communication manager 140 and/or transmission component 1104, depicted in FIG. 11) an indication of the COT.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include one or more of a determination component 1108 and/or a monitoring component 1110, among other examples.

In some aspects, the apparatus 1100 may be configured to perform one or more operations described herein in connection with FIGS. 3, 4A-4C, 5A-5C, and/or 6A-6B. Additionally, or alternatively, the apparatus 1100 may be configured to perform one or more processes described herein, such as process 700 of FIG. 7, process 800 of FIG. 8, process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

In some aspects, the apparatus 1100 may transmit feedback on a sidelink channel. The determination component 1108 may determine whether a PSFCH transmission is scheduled during a COT. The determination component 1108 may include a modem, a modulator, a transmit MIMO processor, a transmit processor, a controller/processor, a memory, or a combination thereof, of the UE described in connection with FIG. 2. Accordingly, the transmission component 1104 may transmit the PSFCH transmission using a first set of resources based at least in part on the determination component 1108 determining that the PSFCH transmission is scheduled outside the COT. Alternatively, the transmission component 1104 may transmit the PSFCH transmission using a second set of resources based at least in part on the determination component 1108 determining that the PSFCH transmission is scheduled in the COT.

In some aspects, the reception component 1102 may receive SCI indicating an instance in the second set of resources to use for the PSFCH transmission. Alternatively, the reception component 1102 may receive an indication of the COT indicating which resource pool, of a plurality of resource pools in the second set of resources, to use for the PSFCH transmission. Alternatively, the reception component 1102 may receive SCI indicating which resource pool, of a plurality of resource pools in the second set of resources, to use for the PSFCH transmission.

Alternatively, the transmission component 1104 may transmit the PSFCH transmission according to a set of HARQ timelines based at least in part on the determination component 1108 determining that the PSFCH transmission is scheduled outside the COT. Similarly, the transmission component 1104 may transmit the PSFCH transmission according to a subset of the set of HARQ timelines based at least in part on the determination component 1108 determining that the PSFCH transmission is scheduled in the COT.

In some aspects, the apparatus 1100 may receive feedback on a sidelink channel. Accordingly, the monitoring component 1110 may monitor a PSFCH using a first set of resources that is associated with feedback received during a COT. The monitoring component 1110 may include one or more antennas, a modem, a demodulator, a MIMO detector, a receive processor, a controller/processor, a memory, or a combination thereof, of the UE described in connection with FIG. 2. Additionally, or alternatively, the monitoring component 1110 may monitor the PSFCH using a second set of resources that is associated with feedback received outside the COT. In some aspects, the reception component 1102 may initiate the COT, and the transmission component 1104 may transmit an indication of the COT.

In some aspects, the transmission component 1104 may transmit SCI indicating an instance in the second set of resources to use. Alternatively, the transmission component 1104 may transmit an indication of the COT indicating which resource pool, of a plurality of resource pools in the second set of resources, to use. Alternatively, the transmission component 1104 may transmit SCI indicating which resource pool, of a plurality of resource pools in the second set of resources, to use.

Alternatively, the monitoring component 1110 may monitor a PSFCH according to a subset of a set of HARQ timelines that is associated with feedback received during a COT. Further, the monitoring component 1110 may monitor the PSFCH according to remaining HARQ timelines in the set of HARQ timelines, that are associated with feedback received outside the COT, based at least in part on receiving no feedback on the PSFCH during the subset of HARQ timelines. In some aspects, the reception component 1102 may initiate the COT, and the transmission component 1104 may transmit an indication of the COT.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: determining whether a physical sidelink feedback channel (PSFCH) transmission is scheduled during a channel occupancy time (COT); and transmitting the PSFCH transmission using a first set of resources based at least in part on determining that the PSFCH transmission is scheduled outside the COT, or transmitting the PSFCH transmission using a second set of resources based at least in part on determining that the PSFCH transmission is scheduled in the COT.
Aspect 2: The method of Aspect 1, wherein determining whether the PSFCH is scheduled during the COT comprises: receiving an indication of the COT.
Aspect 3: The method of any of Aspects 1 through 2, wherein the first set of resources is associated with a first periodicity and a first offset, and the second set of resources is associated with a second periodicity and a second offset.
Aspect 4: The method of Aspect 3, wherein the second periodicity is longer than the first periodicity.
Aspect 5: The method of any of Aspects 1 through 4, wherein the PSFCH transmission is for a COT-initiator node, and the PSFCH transmission is transmitted using the second set of resources.
Aspect 6: The method of any of Aspects 1 through 4, wherein the PSFCH transmission is for a node not associated with the COT, and the PSFCH transmission is transmitted using an instance in the second set of resources that is latest in time.
Aspect 7: The method of any of Aspects 1 through 4, further comprising: receiving sidelink control information (SCI) indicating an instance in the second set of resources to use for the PSFCH transmission, wherein the PSFCH transmission is for a COT-initiator UE.
Aspect 8: The method of any of Aspects 1 through 4, wherein the second set of resources comprises a plurality of resource pools.
Aspect 9: The method of Aspect 8, further comprising: receiving an indication of the COT indicating which resource pool, of the plurality of resource pools, to use for the PSFCH transmission.
Aspect 10: The method of Aspect 8, further comprising: receiving sidelink control information (SCI) indicating which resource pool, of the plurality of resource pools, to use for the PSFCH transmission, wherein the PSFCH transmission is for a COT-initiator UE.
Aspect 11: The method of Aspect 8, wherein the PSFCH transmission is for a node not associated with the COT, and the PSFCH transmission is transmitted using a resource pool, in the plurality of resource pools, that has an instance latest in time.
Aspect 12: The method of any of Aspects 1 through 11, wherein the first set of resources is associated with a first set of hybrid automatic repeat request (HARQ) timelines, and the second set of resources is associated with a second set of HARQ timelines.
Aspect 13: A method of wireless communication performed by a user equipment (UE), comprising: monitoring a physical sidelink feedback channel (PSFCH) using a first set of resources that is associated with feedback received during a channel occupancy time (COT); monitoring the PSFCH using a second set of resources that is associated with feedback received outside the COT; or a combination thereof.
Aspect 14: The method of Aspect 13, further comprising: initiating the COT and transmitting an indication of the COT.
Aspect 15: The method of any of Aspects 13 through 14, wherein the first set of resources is associated with a first periodicity and a first offset, and the second set of resources is associated with a second periodicity and a second offset.
Aspect 16: The method of Aspect 15, wherein the second periodicity is longer than the first periodicity.
Aspect 17: The method of any of Aspects 13 through 16, further comprising: transmitting sidelink control information (SCI) indicating an instance in the second set of resources to use, wherein the UE is a COT-initiator UE.
Aspect 18: The method of any of Aspects 13 through 16, wherein the second set of resources comprises a plurality of resource pools.
Aspect 19: The method of Aspect 18, further comprising: transmitting an indication of the COT indicating which resource pool, of the plurality of resource pools, to use.
Aspect 20: The method of Aspect 18, further comprising: transmitting sidelink control information (SCI) indicating which resource pool, of the plurality of resource pools, to use, wherein the UE is a COT-initiator UE.
Aspect 21: The method of any of Aspects 13 through 20, wherein the first set of resources is associated with a first set of hybrid automatic repeat request (HARQ) timelines, and the second set of resources is associated with a second set of HARQ timelines.
Aspect 22: A method of wireless communication performed by a user equipment (UE), comprising: determining whether a physical sidelink feedback channel (PSFCH) transmission is scheduled during a channel occupancy time (COT); and transmitting the PSFCH transmission according to a set of hybrid automatic repeat request (HARQ) timelines based at least in part on determining that the PSFCH transmission is scheduled outside the COT, or transmitting the PSFCH transmission according to a subset of the set of HARQ timelines based at least in part on determining that the PSFCH transmission is scheduled in the COT.
Aspect 23: The method of Aspect 22, wherein the determining whether the PSFCH is scheduled during the COT comprises: receiving an indication of the COT.
Aspect 24: A method of wireless communication performed by a user equipment (UE), comprising: monitoring a physical sidelink feedback channel (PSFCH) according to a subset of a set of hybrid automatic repeat request (HARQ) timelines that is associated with feedback received during a channel occupancy time (COT); and monitoring the PSFCH according to remaining HARQ timelines in the set of HARQ timelines, that are associated with feedback received outside the COT, based at least in part on receiving no feedback on the PSFCH during the subset of HARQ timelines.
Aspect 25: The method of Aspect 24, further comprising: initiating the COT and transmitting an indication of the COT.
Aspect 26: An apparatus for wireless communication at a device, comprising a processor; memory coupled with the processor; and instructions stored in the memory and executable by the processor to cause the apparatus to perform the method of one or more of Aspects 1-12.
Aspect 27: A device for wireless communication, comprising a memory and one or more processors coupled to the memory, the one or more processors configured to perform the method of one or more of Aspects 1-12.
Aspect 28: An apparatus for wireless communication, comprising at least one means for performing the method of one or more of Aspects 1-12.
Aspect 29: A non-transitory computer-readable medium storing code for wireless communication, the code comprising instructions executable by a processor to perform the method of one or more of Aspects 1-12.
Aspect 30: A non-transitory computer-readable medium storing a set of instructions for wireless communication, the set of instructions comprising one or more instructions that, when executed by one or more processors of a device, cause the device to perform the method of one or more of Aspects 1-12.
Aspect 31: An apparatus for wireless communication at a device, comprising a processor; memory coupled with the processor; and instructions stored in the memory and executable by the processor to cause the apparatus to perform the method of one or more of Aspects 13-21.
Aspect 32: A device for wireless communication, comprising a memory and one or more processors coupled to the memory, the one or more processors configured to perform the method of one or more of Aspects 13-21.
Aspect 33: An apparatus for wireless communication, comprising at least one means for performing the method of one or more of Aspects 13-21.
Aspect 34: A non-transitory computer-readable medium storing code for wireless communication, the code comprising instructions executable by a processor to perform the method of one or more of Aspects 13-21.
Aspect 35: A non-transitory computer-readable medium storing a set of instructions for wireless communication, the set of instructions comprising one or more instructions that, when executed by one or more processors of a device, cause the device to perform the method of one or more of Aspects 13-21.
Aspect 36: An apparatus for wireless communication at a device, comprising a processor; memory coupled with the processor; and instructions stored in the memory and executable by the processor to cause the apparatus to perform the method of one or more of Aspects 22-23.
Aspect 37: A device for wireless communication, comprising a memory and one or more processors coupled to the memory, the one or more processors configured to perform the method of one or more of Aspects 22-23.
Aspect 38: An apparatus for wireless communication, comprising at least one means for performing the method of one or more of Aspects 22-23.
Aspect 39: A non-transitory computer-readable medium storing code for wireless communication, the code comprising instructions executable by a processor to perform the method of one or more of Aspects 22-23.
Aspect 40: A non-transitory computer-readable medium storing a set of instructions for wireless communication, the set of instructions comprising one or more instructions that, when executed by one or more processors of a device, cause the device to perform the method of one or more of Aspects 22-23.
Aspect 41: An apparatus for wireless communication at a device, comprising a processor; memory coupled with the processor; and instructions stored in the memory and executable by the processor to cause the apparatus to perform the method of one or more of Aspects 24-25.
Aspect 42: A device for wireless communication, comprising a memory and one or more processors coupled to the memory, the one or more processors configured to perform the method of one or more of Aspects 24-25.
Aspect 43: An apparatus for wireless communication, comprising at least one means for performing the method of one or more of Aspects 24-25.
Aspect 44: A non-transitory computer-readable medium storing code for wireless communication, the code comprising instructions executable by a processor to perform the method of one or more of Aspects 24-25.
Aspect 45: A non-transitory computer-readable medium storing a set of instructions for wireless communication, the set of instructions comprising one or more instructions that, when executed by one or more processors of a device, cause the device to perform the method of one or more of Aspects 24-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”' a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communications at a user equipment (UE), comprising:
a processor;
memory coupled with the processor; and
instructions stored in the memory and executable by the processor to cause the apparatus to:
determine whether a physical sidelink feedback channel (PSFCH) transmission is scheduled during a channel occupancy time (COT); and
transmit the PSFCH transmission using a first set of resources based at least in part on determining that the PSFCH transmission is scheduled outside the COT, or transmit the PSFCH transmission using a second set of resources based at least in part on determining that the PSFCH transmission is scheduled in the COT.

2. The apparatus of claim 1, wherein the instructions, to determine whether the PSFCH is scheduled during the COT, are executable by the processor to cause the apparatus to:
receive an indication of the COT.

3. The apparatus of claim 1, wherein the first set of resources is associated with a first periodicity and a first offset, and the second set of resources is associated with a second periodicity and a second offset.

4. The apparatus of claim 3, wherein the second periodicity is longer than the first periodicity.

5. The apparatus of claim 1, wherein the PSFCH transmission is for a COT-initiator node, and the PSFCH transmission is transmitted using the second set of resources.

6. The apparatus of claim 1, wherein the PSFCH transmission is for a node not associated with the COT, and the PSFCH transmission is transmitted using an instance in the second set of resources that is latest in time.

7. The apparatus of claim 1, wherein the instructions are further executable by the processor to cause the apparatus to:
receive sidelink control information (SCI) indicating an instance in the second set of resources to use for the PSFCH transmission,
wherein the PSFCH transmission is for a COT-initiator UE.

8 The apparatus of claim 1, wherein the second set of resources comprises a plurality of resource pools.

9. The apparatus of claim 8, wherein the instructions are further executable by the processor to cause the apparatus to:
receive an indication of the COT indicating which resource pool, of the plurality of resource pools, to use for the PSFCH transmission.

10. The apparatus of claim 8, wherein the instructions are further executable by the processor to cause the apparatus to:
receive sidelink control information (SCI) indicating which resource pool, of the plurality of resource pools, to use for the PSFCH transmission,
wherein the PSFCH transmission is for a COT-initiator UE.

11. The apparatus of claim 8, wherein the PSFCH transmission is for a node not associated with the COT, and the PSFCH transmission is transmitted using a resource pool, in the plurality of resource pools, that has an instance latest in time.

12. The apparatus of claim 1, wherein the first set of resources is associated with a first set of hybrid automatic repeat request (HARQ) timelines, and the second set of resources is associated with a second set of HARQ timelines.

13. An apparatus for wireless communications at a user equipment (UE), comprising:
a processor;
memory coupled with the processor; and
instructions stored in the memory and executable by the processor to cause the apparatus to:
monitor a physical sidelink feedback channel (PSFCH) using a first set of resources that is associated with feedback received during a channel occupancy time (COT);
monitor the PSFCH using a second set of resources that is associated with feedback received outside the COT; or
a combination thereof.

14. The apparatus of claim 13, wherein the instructions are further executable by the processor to cause the apparatus to:
initiate the COT and transmit an indication of the COT.

15. The apparatus of claim 13, wherein the first set of resources is associated with a first periodicity and a first offset, and the second set of resources is associated with a second periodicity and a second offset.

16. The apparatus of claim 15, wherein the second periodicity is longer than the first periodicity.

17. The apparatus of claim 13, wherein the instructions are further executable by the processor to cause the apparatus to:
transmit sidelink control information (SCI) indicating an instance in the second set of resources to use,
wherein the UE is a COT-initiator UE.

18. The apparatus of claim 13, wherein the second set of resources comprises a plurality of resource pools.

19. The apparatus of claim 18, wherein the one or more processors are further configured to:
transmit an indication of the COT indicating which resource pool, of the plurality of resource pools, to use.

20. The apparatus of claim 18, wherein the instructions are further executable by the processor to cause the apparatus to:
transmit sidelink control information (SCI) indicating which resource pool, of the plurality of resource pools, to use,
wherein the UE is a COT-initiator UE.

21. The apparatus of claim 13, wherein the first set of resources is associated with a first set of hybrid automatic repeat request (HARQ) timelines, and the second set of resources is associated with a second set of HARQ timelines.

22. An apparatus for wireless communications at a user equipment (UE), comprising:
a processor;
memory coupled with the processor; and
instructions stored in the memory and executable by the processor to cause the apparatus to:
determine whether a physical sidelink feedback channel (PSFCH) transmission is scheduled during a channel occupancy time (COT); and
transmit the PSFCH transmission according to a set of hybrid automatic repeat request (HARQ) timelines based at least in part on determining that the PSFCH transmission is scheduled outside the COT, or transmit the PSFCH transmission according to a subset of the set of HARQ timelines based at least in part on determining that the PSFCH transmission is scheduled in the COT.

23. The apparatus of claim 22, wherein the instructions, to determine whether the PSFCH is scheduled during the COT, are executable by the processor to cause the apparatus to:
receive an indication of the COT.

24. An apparatus for wireless communications at a user equipment (UE), comprising:
a processor;
memory coupled with the processor; and
instructions stored in the memory and executable by the processor to cause the apparatus to:
monitor a physical sidelink feedback channel (PSFCH) according to a subset of a set of hybrid automatic repeat request (HARQ) timelines that is associated with feedback received during a channel occupancy time (COT); and
monitor the PSFCH according to remaining HARQ timelines in the set of HARQ timelines, that are associated with feedback received outside the COT, based at least in part on receiving no feedback on the PSFCH during the subset of HARQ timelines.

25. The apparatus of claim 24, wherein the instructions are further executable by the processor to cause the apparatus to:
initiate the COT and transmit an indication of the COT.
